(19) United States
(12) Patent Application Publication
(10) Pub. No.: US 2023/0232124 A1
(43) Pub. Date: Jul. 20, 2023

(54) HIGH-SPEED IMAGING APPARATUS AND IMAGING METHOD

(71) Applicant: HERIOT-WATT UNIVERSITY, Edinburgh (GB)

(72) Inventors: Xu WANG, Edinburgh (GB); Amirali MATIN, Edinburgh (GB)

(73) Assignee: HERIOT-WATT UNIVERSITY, Edinburgh (GB)

(21) Appl. No.: 18/008,427

(22) PCT Filed: Jun. 30, 2021
(86) PCT No.: PCT/GB2021/051368

§ 371 Date: Dec. 5, 2022

(30) Foreign Application Priority Data
Jun. 5, 2020 (GB) 2008485.1

(51) Int. Cl. H04N 23/951; H04N 25/47; H04N 23/84; H04N 23/55; G02B 26/08

(52) U.S. Cl. CPC H04N 23/951; H04N 25/47; H04N 23/84; H04N 23/55; G02B 26/0816

(57) ABSTRACT

An imaging apparatus (100, 300) comprising: an optical encoder (150, 350) configured to provide an encoded image of an object (110) with at least one mask pattern; a rotating mirror (170) configured to receive and project said encoded image; and an image sensor (180) configured to receive said encoded; wherein, said rotating mirror (170) is operable such that a plurality of encoded images, which are individually projected by said rotating mirror (170) are spatially shifted as a result of rotation of said rotating mirror (170), are swept across said image sensor (180).

### TECHNICAL FIELD

The present invention relates to an imaging apparatus and an imaging method for high speed imaging of ultrafast transient phenomena.

### BACKGROUND

High-speed imaging has shown an exceptional potential in capturing ultrafast transient phenomena in a variety of applications, such as screening the physiological processes in biological tissues, high-throughput blood cells screening, fluorescence confocal and lifetime microscopy, which require cameras with capture rates between kilo frames per second (Kfps) to mega frames per second (Mfps). In the fields of biomedical research and clinical applications for example, high-speed imaging allows the detection and tracking of cells, plasma, and other molecules of interest in a specimen individually or as a group with high sensitivity and precision. Rotating mirror cameras are among the first commercially available imaging instruments that can achieve a frame rate of as high as 25 Mfps. The principle of rotating mirror camera technology relies on the rotation of a single mirror that directed the incident light (frames) towards a film strip (e.g., rotating mirror camera disclosed in U.S. Pat. No. 3,122,052) that was replaced by the array of Charged-Coupled Devices (CCD) in the later development stages (e.g., Brandaris 128 described in the article of Gelderblom E C, et al., 2012, Rev. Sci. Instrum., 83, 103706).

The present version of Brandaris 128 imaging system is still one of the fastest commercial high speed cameras which can provide a maximum frame rate of 25 Mfps and record more than 100 consecutive frames. However, the requirements of using 128 highly sensitive, un-intensified CCD image sensors and custom-designed high speed CCD control electronics for high speed image acquisition and a helium-driven turbine for high speed mirror rotation have led to several disadvantages such as large physical dimensions, high build and maintenance costs, lack of flexibility and requirement of high storage capacities.

Some of aforementioned disadvantages are common to many other conventional high-speed imaging systems and thus greatly hinder their applications in many technical environments, especially in those resource-limited areas. For example, in microfluidics studies and lab-on-chip applications, the lack of inexpensive and compact imaging systems has imposed a constraint on the visualisation aspect of studies of many dynamic events, such as study of the blood plasma separation (BPS) methods for cell and DNA analysis by means of acoustic, electric and magnetic fields, micro-filtration techniques as well as BPS chips. The typical dimension of feed channels of those BPS chips can vary anywhere between sub-microns (μm) and millimetres (mm). It is thus desirable to have an inexpensive, flexible and compact (preferably portable) high-speed imaging apparatus that allows for easy and quick adaptation to the change of object dimensions. The present invention aims to provide such a solution.

### SUMMARY OF INVENTION

According to a first aspect of the invention, there is provided an imaging apparatus, comprising: an optical encoder configured to provide an encoded image by encoding an image of an object with at least one mask pattern; a rotating mirror configured to rotate and to receive and subsequently project the encoded image; and an image sensor configured to receive the encoded image projected by the rotating mirror; wherein, the rotating mirror is operable to single-directionally rotate a rotation angle such that a plurality of the encoded images which are individually projected by the rotating mirror at any rotation moment and are spatially shifted as a result of rotation of the rotating mirror, are swept across the image sensor for a single image acquisition.

In this way, a compact, low cost, and high speed imaging apparatus is provided. The imaging apparatus is capable of imaging non-repeatable dynamic events at ultra-high frame rates for longer capture durations. Moreover, the imaging apparatus is capable of enabling real-time data encryption, thereby eliminating potential exposure of captured image data.

Preferably, the plurality of the projected encoded images are detected by the image sensor as a plurality of detected encoded images, and wherein, the plurality of detected encoded images are spatially shifted by a single pixel size of the image sensor. And more preferably, the plurality of the projected encoded images cover an entire sensing area of the image sensor.

In this way, the number of the total image frames that are simultaneously captured by the image sensor with a single image acquisition can be maximized.

Preferably, each of the plurality of the projected encoded images comprises a pixel size substantially that of said image sensor

Preferably, the optical encoder comprises a physical mask with at least one fixed mask pattern.

Preferably, the optical encoder comprises a transmissive spatial light modulator (SLM) or a reflective SLM.

Preferably, the optical encoder comprises at least one variable mask pattern, and further wherein, the at least one variable mask pattern is arranged to be adjustable during operation of the imaging apparatus.

Preferably, the at least one mask pattern comprises one or more binary patterns.

Preferably, the image apparatus further comprises a first optical element configured to convey the encoded image onto the rotating mirror.

Preferably, the first optical element is configured to focus the encoded image onto the rotating mirror and preferably comprises an optical lens or a curved mirror.

Preferably, the imaging apparatus further comprises a second optical element configured to form the image of the object on the optical encoder.

Preferably, the second optical element comprises any selected from the range: an optical lens, a curved mirror, an optical assembly.

Preferably, the image of the object is formed with natural light.

Preferably, the image of the object is formed after illumination of the object with an external light source.

Preferably, the image of the object is formed with fluorescence emitted from the object excited by the external light source.

Preferably, the imaging apparatus further comprising a control unit operable to perform one or more operation tasks.

Preferably, the control unit is operable to apply at least one mask pattern to the optical encoder.

Preferably, the control unit is operable to calibrate the imaging apparatus with the at least one mask pattern.

Preferably, the control unit is operable to perform one or more image acquisitions so as to capture the plurality of the detected encoded images.

Preferably, the control unit is operable to command the rotating mirror to single-directionally rotate the rotation angle.

Preferably, the control unit is operable to perform data reconstruction in order to reconstruct the plurality of the detected encoded images into original images of the object.

Preferably, the control unit is operable to run a data reconstruction algorithm which is based on alternating direction method of multipliers with total-variation regularizer (ADMM-TV) method.

According a second aspect of the invention, there is provided a method of high speed imaging, comprising: generating an encoded image by encoding an image of an object with at least one mask pattern; receiving and subsequently projecting the encoded image by a rotating mirror configured to rotate; and receiving the encoded image projected from the rotating mirror by an image sensor; wherein, by single-directionally rotating the rotating mirror a rotation angle, a plurality of the encoded images which are individually projected by the rotating mirror at any rotation moment and are spatially shifted as a result of rotation of the rotating mirror, are swept across the image sensor for a single image acquisition.

Preferably, the method of high speed imaging further comprises: obtaining a plurality of detected encoded images by detecting the plurality of the projected encoded images, wherein, the plurality of detected encoded images are spatially shifted by a single pixel size of said image sensor.

Preferably, the method of high speed imaging further comprises: generating one or more calibration trace lines by using one or more calibration blocks; correcting position errors of the encoded images on the image sensor by using the one or more calibration trace lines.

Preferably, the method of high speed imaging further comprises: reconstructing the plurality of detected encoded images for the single image acquisition.

Preferably, the reconstructing of the plurality of the detected encoded images is conducted by a data reconstruction algorithm which is based on alternating direction method of multipliers with total-variation regularizer (ADMM-TV) method.

Preferably, the method of high speed imaging further comprises: separating the plurality of detected encoded images into three sets of single-coloured image data corresponding respectively to red, green and blue channels of the image sensor; reconstructing each of the three sets of single-coloured image data into a set of single-coloured original images by using the data reconstruction algorithm such that three sets of single-coloured original images are obtained; and generating a set of coloured original images by merging corresponding images of the three sets of single-coloured original images.

### BRIEF DESCRIPTION OF THE DRAWINGS

Embodiments of the invention will now be described, by way of example only, by reference to the accompanying drawings, in which:

FIG. 1 schematically illustrates a first configuration of the high speed imaging apparatus in accordance with an embodiment: (a) optical setup; (b) 2-dimensional (2D) encoded image frames captured on the image sensor by a single image acquisition;

FIG. 2 schematically illustrates an example 2D binary mask pattern with a 1:1 ratio between the number of opaque pixels and the number of transparent pixels, the black squares representing opaque pixels and the white squares representing transparent pixels;

FIG. 3 schematically illustrates a second configuration of the high speed imaging apparatus in accordance with an embodiment: (a) optical setup; (b) 2D encoded image frames captured on the image sensor by a single image acquisition;

FIG. 4 schematically illustrates the projection of a focused 2D raw image onto the top surface of a reflective optical encoder used in the embodiment of FIG. 3;

FIG. 5 shows a flowchart of operation of the high speed imaging apparatus in accordance with an embodiment;

FIG. 6 compares (a) an example designed mask pattern with (a) the corresponding detected pattern on the image; and

FIG. 7 shows an example compressed and encoded image after taking a single image acquisition or scan of a static scene which contains a trace line of a calibration block generated as a result of mirror sweeping.

### BASIC OPERATING PRINCIPLE

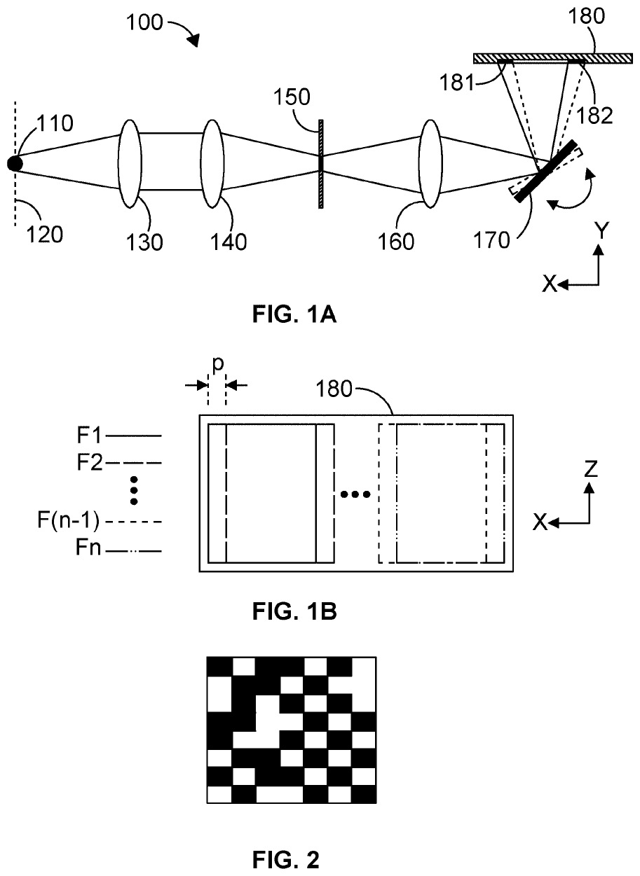

This section will describe the basic operating principle that all the embodiments disclosed herein follow. In the imaging stage, the intensity distribution of a 3-dimensional (3D) spatio-temporal scene (e.g., X, Z, T in FIG. 1), denoted as xεR^{MNF×1}, is focused on an optical encoder configured to provide at least one mask pattern, denoted as A∈R^{MNF×MNF}, where M, N and F denote the number of rows, columns and the total number of frames respectively. Individual 2-dimensional (2D) image frames formed at different instances of time are encoded by the same mask pattern and subsequently direct to a rotating mirror configured to rotate stepwise in at least the plane of propagation of the images. The rotation of the rotating mirror sweeps a plurality of the encoded 2D image frames across the sensing area of an image sensor and overlaps them partially during a single exposure for a single image acquisition. As a result of the rotation of the rotating mirror, any two adjacent encoded 2D image frames on the image sensor will have a relative spatial shift. The shifting and overlapping functions on the image sensor can be denoted as T∈R^{MN+(F-1)M×MNF}. The rotation of the rotating mirror also gives rise to mechanical errors resulting in a secondary vertical shift, denoted as C∈R^{MNF×MNF}, for each partially overlapping 2D image frame. Such a secondary vertical shift is taken into consideration when performing image data (or video) reconstruction.

In the data reconstruction stage, the alternating direction method of multipliers with total-variation regularizer (ADMM-TV) may be used as the optimization algorithm. The sparsity of the data are promoted in the temporal domain and by adopting the TV prior, the edge features in the reconstructed frames can be immensely preserved which can be an essential requirement in the applications such as high-throughput cell imaging and feature classification. Compressive sensing is proven to be one of the key and fundamental data acquisition frameworks with implementations in various types of applications such as video compressive sensing for motion detection and compensation, multiscale photography and bio-imaging.

With the ADMM-TV method, video reconstruction of the captured spatio-temporal scene can be achieved by minimising the cost function, which is expressed as:

$$\hat{x} = {argmin}_{x} \frac{1}{2} {‖ y = TCAx ‖}_{2}^{2} + {ρ}_{k} {‖ Dx ‖}_{1} , \qquad [ 1 ]$$

∥.∥₂² where denotes the l² norm, y∈R^{MN+(F-1)M×1} is the compressed and encoded spatio-temporal scene on the image sensor, D is a regularization function that promotes sparsity in the temporal domain of the dynamic scene, and ρₖ is the regularization parameter that updates periodically based on the obtained results at the corresponding iteration.

The achieved frame rates from the rotating mirror imaging apparatus is formulated as:

$${F}_{r} \approx \frac{2 π \cdot R \cdot L}{p} ( fps ) , subject to p << L , \qquad [ 2 ]$$

where R is the rotation speed of the rotating mirror (rounds per second), L is the orthogonal distance between the mirror and the detector surface and p is the width of each pixel in the detector (the distance between adjacent frames). As indicated by equation [2] above, in order to capture as many image frames as possible for a given imaging apparatus, it is preferable to set the frame separation length cp to the single pixel size/width of the image sensor, thereby enabling a single pixel shift between the adjacent frames. Furthermore, in order to achieve a high frame rate, it is preferable to minimize the frame separation length p while simultaneously maximizing the rotation speed R and the mirror-detector distance L. Depending on applications, the frame rate of the imaging apparatus can range from 1 frame per second (fps) to several billion fps.

### DETAILED DESCRIPTION OF THE EMBODIMENTS

In this section, different embodiments of the imaging apparatus will be described in detail. Although these embodiments may have different configurations and/or components, they are all based on substantially the same operation principle. The operation principle of the proposed imaging apparatus is described as follows:

FIGS. 1 to 7 are related to embodiments of an imaging apparatus which comprises: an optical encoder configured to provide an encoded image by encoding an image of an object with at least one mask pattern; a rotating mirror configured to rotate and to receive and subsequently project the encoded image; and an image sensor configured to receive the encoded image projected by the rotating mirror; wherein, the rotating mirror is operable to single-directionally rotate a rotation angle such that a plurality of the encoded images which are individually projected by the rotating mirror at any rotation moment and are spatially shifted as a result of rotation of the rotating mirror, are swept across the image sensor for a single image acquisition.

FIG. 1(a) is a schematic diagram depicting a first configuration of the proposed imaging apparatus in accordance with an embodiment. As shown in FIG. 1(a), an objective lens 130 may be used to collect light from a dynamic scene or an object 110 within a field of view (FOV) in an object plane 120. In some embodiments, the objective lens 130 may be a lens assembly, such as for example, an infinity-corrected microscopic objective. In other embodiments, the objective lens 130 may be a singlet lens. The FOV and its distance to the objective lens 130 are determined by the parameters of the objective lens 130, such as numerical aperture (NA) and focal length (FL). In this embodiment, the object plane OP may coincide with the focal plane of the objective lens 130. In other words, the distance between the object plane 120 and the objective 130 may be equal to the focal length of the objective 130.

In some embodiments, an object support may be employed to hold an object 110 to be imaged. In some other embodiments, the object support may be movable by means of one or more actuators and precise positioning of those actuators may be controlled by a control unit (not shown) of the imaging apparatus. In this way, 3D spatial scanning of an object 110 is attainable. The image-forming light collected by the objective lens 130 may be subsequently focused onto an optical encoder by means of a first tube lens 140. As such, an intermediate 2D raw image may be formed on the optical encoder. In some embodiments, such as the embodiment 100 of FIG. 1, the optical encoder may be operated in a transmission configuration where the input raw image and the output encoded image propagate along the same direction. The objective lens 130 and the first tube lens 140 may be configured to form a first telecentric lens system.

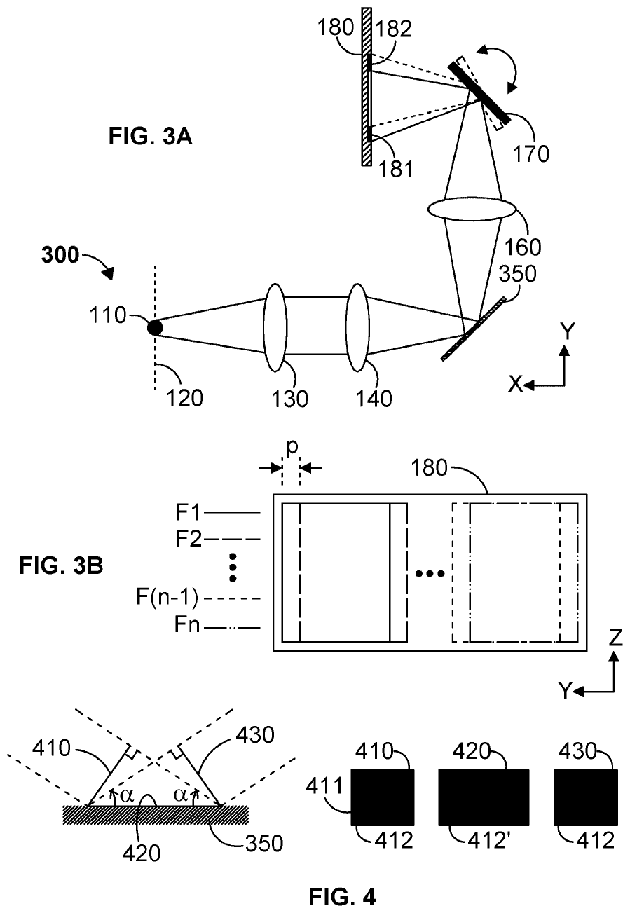

Subsequently, this intermediate 2D raw image on the transmissive optical encoder 150 may be encoded with a mask pattern. The transmissive optical encoder 150 may be for example a transmissive spatial light modulator (SLM) such as a liquid crystal based SLM or a physical mask. The physical mask may comprise a fixed mask pattern. Or it may comprise a number of different patterns that may be distributed spatially across the physical mask. Such a physical mask with multiple different patterns may be translatable relative to the incident raw image such that different mask patterns can be applied to the incident raw image when needed. Translation of the physical mask may be enabled by one or more actuators which may be controlled by the control unit of the imaging apparatus. In some different embodiments, the optical encoder may be operated in a reflection configuration where an angle is formed between the propagation direction of the input raw image and the propagation direction of the output encoded image. The angle between the input and output propagation directions may be governed by the characteristics of the reflective optical encoder, which may be a reflective SLM such as a digital micro-mirror device (DMD). The details of the reflection configuration is illustrated in FIG. 3 and will be described in the later part of this disclosure.

When SLM, e.g., a liquid crystal based SLM or a DMD, is used as the optical encoder, the mask pattern be variable during imaging. For example, in some embodiments, a different mask pattern may be applied for each new image acquisition and/or at each new object position (e.g., if a movable object support is used to change object position). In other embodiments, various different mask pattern may be dynamically formed even during an image acquisition. In a typical embodiment, 2D binary mask patterns may be used. The 2D binary mask patterns may be formed with a plurality of opaque and transparent pixels. In some embodiments, the 2D binary mask patterns may have a 1:1 ratio between the number of opaque pixels and the number of transparent pixels. In other embodiments, other different ratios may be used, such as 1:2, 1:3, 1:4, 1:5, 2:1, 3:1, 4:1, or 5:1. In different embodiments, different types of mask patterns may be used, e.g., ternary or quaternary patterns. The pixel size of mask patterns may be design-specific and may depend on the pixel size of an image sensor 180 that is used in the image apparatus and the magnification of the lens system used in-between the encoder 150 and the image sensor 180. In some preferred embodiments, the size of the imaged pattern pixels seen by the image sensor 180 may be substantially the same as that of the sensor pixels.

In the embodiment 100 of FIG. 1, a physical mask with a fixed 2D binary mask pattern may be used as the transmissive optical encoder 150. The binary pattern may have a 1:1 ratio between the number of opaque pixels and the number of transparent pixels. The physical mask may comprise a patterned area sufficiently larger than that of the intermediate raw image focused by the first tube lens 140. FIG. 2 schematically illustrates an example 2D binary mask pattern with a 1:1 ratio between the number of opaque pixels and the number of transparent pixels. Upon leaving the physical mask, the encoded image may be re-imaged by a second tube lens 160 onto a rotating mirror 170 which may subsequently divert the encoded image onto the image sensor 180. In this embodiment, the first tube lens 140 and the second tube lens 160 may be configured to form a second telecentric lens system.

The telecentric lens system may result in a magnification factor which links the pixel size of the mask pattern of the encoder 150 and the pixel size of the image sensor 180. Specifically, the pixel size of the 2D encoded image received on the image sensor 180 may be substantially the same as the pixel size of the image sensor 180.

At a default position, the rotating mirror 170 may divert the image-forming light by an angle of 90°. This means when the rotating mirror 170 is at its default position, the propagation directions of the image-forming light before and after the reflection on the rotating mirror 170 are perpendicular to each other. The rotating mirror 170 may be mounted on a movable mirror mount that allows rotational movement in the propagation plane of the image-forming light, or the X-Y plane as indicated in FIG. 1(a).

Movement of the movable mirror mount may be enabled by one or more actuators, such as for example electric motors, which may be controlled by the control unit of the imaging apparatus. The actuators may allow the rotating mirror 170 to be rotated in a defined plane, e.g., the X-Y plane. At any moment of mirror rotation, an encoded 2D image frame will be reflected or projected by the rotating mirror 170 onto the image sensor 180. Consequently, the rotation of the rotating mirror 170 may sweep a plurality of encoded 2D image frames across the full width (e.g., along the X-axis) of the sensing area of the image sensor 180. Each of the plurality of encoded 2D image frames, e.g., image frames 181, 182 in FIG. 1(a), may contain the spatial information of a dynamic scene (or the object 110 in FIG. 1(a)) at a specific instance of time. However, due to the pixelated nature of the image sensor 180, those projected encoded image frames that are separated less than the pixel size of the image sensor 180 will be viewed or detected as one image frame by the image sensor 180. For example, in a scenario where the plurality of encoded 2D image frames are swept from left to right across the image sensor 180, the left-most image frame is considered to be the first image frame. All the subsequent image frames that are within one pixel size distance to the first image frame will be integrated by the image sensor 180 into the first image frame. The same integration process goes on for other columns of the image sensor 180. As a result, a plurality of detected encoded 2D image frames are obtained.

FIG. 1(b) is a schematic diagram showing the distribution of a plurality of detected 2D image frames (e.g., F1, F2, . . . F(n−1), Fn) across the full width of the sensing area of the image sensor. As illustrated in FIG. 1(b), after a single sweeping period, a plurality of encoded 2D image frames (e.g., F1, F2, . . . F(n−1), Fn) may be detected by the image sensor 180. The plurality of detected encoded 2D image frames may partially overlap with each other and any two adjacent detected 2D image frames, e.g., F1 and F2, or F(n−1) and Fn in FIG. 1(b), may be spatially shifted by a frame separation length p equivalent to a single pixel width of the image sensor 180, for example.

To sequentially project the plurality of individual 2D image frames onto the image sensor 180, the rotating mirror 170 may rotate stepwise by means of e.g., a stepper motor or a piezoelectric motor. At any moment of mirror rotation, an encoded 2D image frame may be projected onto the image sensor 180 at a specific position. Hence, a plurality of encoded image frames can still be projected onto the image sensor 180 even when the rotating mirror moves from the current rotation step to a next rotation step. The rotating mirror 170 may be configured to sweep a rotation angle range and may rotate from one side of the default position to the opposite side. In such a manner, the position of the first projected 2D image frame on the image sensor 180 may correspond to one extreme of a rotation angle range and the position of the last projected 2D image frame may correspond to the other extreme of the same rotation angle range.

The temporal delay between any two adjacent detected 2D image frames may be fixed and may depend on the (fixed) rotation speed of the rotating mirror 170, the orthogonal distance between the rotating mirror 170 and the image sensor 180, and p is the width of each pixel in the detector (the distance between adjacent frames), which are related by equation [2]. The single sweeping period, corresponding to the total exposure time for a single image acquisition, may therefore be the product of the temporal delay between two adjacent pixels and the total pixel number of the image sensor 180. Hence, it may be preferable to use an image sensor 180 with a higher number of pixels in the case where a higher number of image frames is to be obtained by a single image acquisition. In some embodiments, the image sensor 180 may be a CMOS sensor. Whereas, in other embodiments, the image sensor 180 may be a CCD sensor. In some different embodiments, the rotation speed of the rotating mirror 170 may not be constant and consequently the temporal delay between any two adjacent 2D image frames may be variable. After each image acquisition, the plurality of individually encoded, temporally separated, and spatially partially overlapped 2D image frames that are detected by the image sensor 180 may be sent to the control unit for data reconstruction.

FIG. 3(a) is a schematic diagram depicting a second configuration of the proposed imaging apparatus in accordance with an embodiment. FIG. 3(b) is a schematic diagram showing the distribution of a plurality of detected 2D image frames (e.g., F1, F2, . . . F(n−1), Fn) across the full width of the sensing area of the image sensor. In comparison with the embodiment 100 of FIG. 1, the main difference in this second configuration may be the use of a reflective optical encoder 350 rather than the transmissive counterpart in the first configuration. Hence, most of the reference signs used in embodiment 100 are kept in the embodiment 300 of FIG. 3. Similar to the embodiment 100, imaging-forming light from a dynamic scene or an object 110 in a field of view may be collected by an objective lens 130 and subsequently focused by a first tube lens 140 onto the reflective optical encoder 350. The focused image-forming light may form an intermediate 2D raw image on the top surface of the reflective optical encoder 350. In some embodiments, mask patterns of the reflective optical encoder 350 may be 2D binary patterns which may comprise a plurality of “ON” pixels and a plurality of “OFF” pixels. The “ON” pixels may correspond to the transparent pixels of the transmissive optical encoder while the “OFF” pixels may correspond to the opaque pixels of the transmissive optical encoder. Those “ON” pixels may reflect some parts of the 2D raw image towards the image sensor 180. In contrast, the “OFF” pixels may either absorb or divert away other parts of the 2D raw image, e.g., towards a beam block. Therefore, the 2D images reflected off the reflective optical encoder 350 may be encoded with the mask pattern. The area of mask patterns may be sufficiently larger than the area of the 2D raw image projected on the surface of the reflective optical encoder 350. The reflective optical encoder 350 may be a simple mirror type reflective mask with a fixed mask pattern, or a DMD which allows for variable mask patterns.

FIG. 4(a) schematically illustrates the projection of the focused 2D raw image onto the surface of the reflective optical encoder. Due to the angled projection, e.g., at an incident angle of a, the projected 2D image 420 on the reflective optical encoder 350 may be elongated along a first axis while unaffected along a second axis. As shown in FIG. 4(b), the elongated size 412′ of the projected 2D image 420 and the original size 412 of the incident raw image 410 may be related as 412′=412/Sin(α). After reflection off the reflective optical encoder 350, the encoded image 430 may have substantially the same aspect ratio as that of the raw image 410. Note that, in FIG. 4, it is assumed that the wavefront of the image-forming light in the region in which the images 410, 420 and 430 are located remains substantially flat.

Similar to the embodiments of the first configuration, the encoded 2D image reflected off the reflective optical encoder 350 may be reimaged by a second tube lens 160 onto a rotating mirror RM which subsequently reflect the encoded 2D image to an image sensor 180. The working principle of the rotating mirror 170 is the same as that described in the embodiment of FIG. 1. The sweeping motion of the rotating mirror 170 may sequentially direct or project a plurality of 2D encoded image frames across the full width (e.g., along the Y-axis) of the sensing area of the image sensor 180. Any two adjacent 2D encoded image frames detected by the image sensor 180 may be shifted by a single pixel width. Again, similar to the embodiment 100 of FIG. 1, the encoded 2D image received on the image sensor SEN may have a pixel size that is substantially the same as the pixel size of the image sensor SEN. However, in comparison to the transmissive configuration where the pixel size of the mask pattern of the transmissive optical encoder (150) may be determined by the pixel size of the image sensor 180 together with the magnification factor of the optical lens system placed in-between, determination of the pixel size of the mask pattern of the reflective optical encoder 350 used in the reflective configuration may additionally take account of the slant incidence of the raw image.

Note that, the aforementioned embodiment configurations are not restrictive. Many other configurations of the imaging apparatus are equally applicable. In some embodiments, the objective lens 120 may be replaced with a telescope assembly which allows for imaging of large and distant objects or dynamic scenes rather than close and microscopic object 110 as in the embodiments 100, 300. In different embodiments, the first tube lens L2 may not be needed to focus a raw image of an object onto the optical encoder 150, 350. In other words, the optical encoder 150, 350 may be sufficiently large to cover the unfocused raw image. In other embodiments, one or both of the tube lenses 140, 160 may be replaced with one or more curved mirrors (e.g., concave spherical mirrors) such that the dimensions of the imaging apparatus can be further reduced and thus the imaging apparatus can be more compact. In typical embodiments, the rotating mirror 170 may be a plane or flat mirror. In some different embodiments, the rotating mirror 170 may be a curved mirror, e.g., a spherical concave mirror.

In some other embodiments, rather than relying on using natural light for illumination of an object or a dynamic scene 110 as in the case of foregoing embodiments, external light sources may be used to illuminate the object or dynamic scene 110. After illumination, light transmitted through and/or reflected off the object or dynamic scene 110 may be collected to form a raw image which will then be encoded by the optical encoder 150, 350 and projected by the rotating mirror 170 onto the image sensor 180. Alternatively or additionally, fluorescence emitted from the object or dynamic scene 110 may be collected to form the raw image. In such a manner, a multimodal high-speed imaging apparatus that is able to image fast moving objects and subsequently reveal both structural and compositional information of the objects can be obtained.

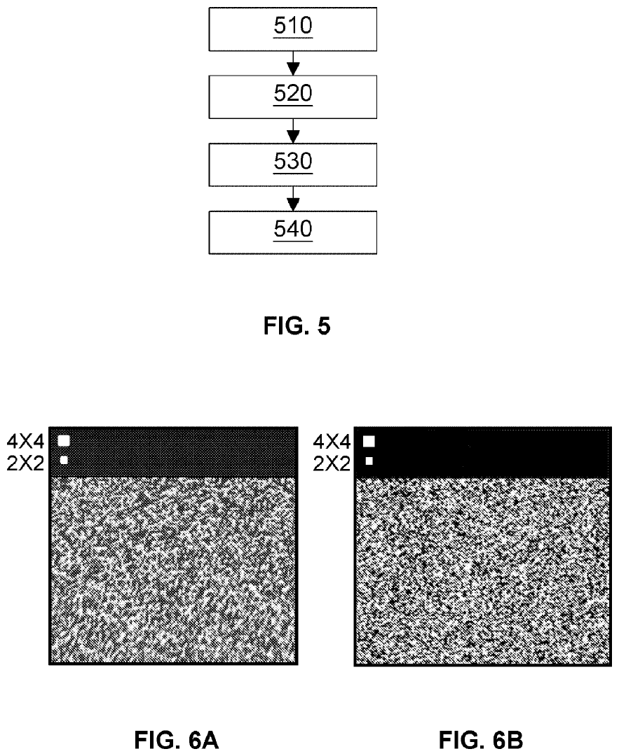

FIG. 5 shows a flowchart of the operation of the image apparatus in accordance with an embodiment. In this embodiment, the operation of the imaging apparatus may comprise for example following four main steps:

At step 510, a mask pattern may be selected. In case of a physical mask being used as the optical encoder 150, 350, the physical mask with one or more suitable mask patterns may be placed into the image apparatus. Alternatively, in case of a SLM or DMD being used the optical encoder 150, 350, then one or more mask patterns may be (digitally) generated and applied to the optical encoder 150, 350 in a sequential manner. In some embodiments, the selection and subsequent application of suitable mask patterns may be carried out fully automatically by the control unit.

At step 520, the image apparatus with the selected one or more mask patterns may be calibrated. In some embodiments, prior to imaging a dynamic scene, a calibration process may be applied on the system.

The first step may be to capture a single image frame of the mask pattern imaged/detected on the image sensor 180. Note that, at this first step, the rotating mirror 170 is static and thus not rotating. It is advantageous to use the detected mask pattern from the image sensor 180 instead of the designed mask pattern in the reconstruction algorithm as it has been found that the designed mask pattern is (slightly) different from the detected pattern on the image sensor 180. Such small difference may be due to the fact that the object resolution (mask resolution) is sufficiently close to the least resolvable resolution of the imaging apparatus which causes a slight light diffraction and hence interference between pixels. Furthermore, in the case where a physical mask with printed mask patterns is used, the individual pattern pixels may have a round shape rather than being square blocks a result of insufficient printing accuracy in the manufacturing process of the mask. This leads to a manufacturing term called “pixel bleeding” where by reaching the printer's resolution, edges of each pixel will mix with those of the adjacent ones and consequently a portion of the light incident on a pixel may also enter the adjacent pixels.

FIG. 6 compares (a) an example designed mask pattern with (a) the corresponding detected pattern on the image. As shown in FIG. 6, the impact of the light distortion and pixel bleeding results in a grey scale (or blurred) mask pattern on the image sensor. It is therefore desirable to use the detected or imaged mask pattern in the reconstruction algorithm and for A∈R^{MNF×MNF} in the above cost function, i.e. equation [1] and the below forward model, i.e. equation [3].

The second step of the calibration may be to extract the motion profile of the rotating mirror 170. Rotation of the rotating mirror 170 enabled by e.g., electric motors may be associated with various types of inaccuracies such as backlash error, vibration at high speeds, missing steps, poor optical alignments and design flaws in the mirror holder attached to the motor. One or more calibration blocks may be provided in the peripheral area of the mask pattern. The calibration blocks may comprise one or more pixels that can either transmit or reflect a portion of the image-forming light towards the image sensor 180. While the encoded 2D image frames are swept across the image sensor 180, the calibration block generates a trace line of its movement which can be utilized to evaluate and calibrate the rotating performance of the rotating mirror 170. Such trace lines are then extracted from the captured image data and used to define the exact position of each detected 2D image frame in the compressed image package.

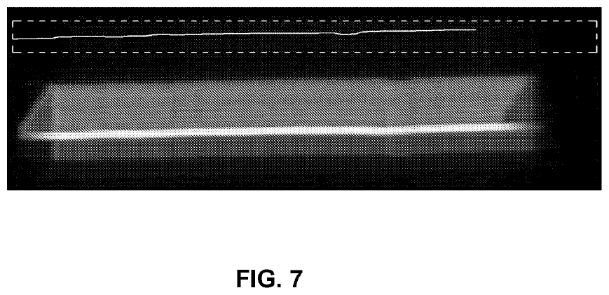

As shown in the example images in FIG. 6, the 2×2 (two pixels by two pixels) calibration block is used as a primary calibration block. However, for the scenes which result in images with lower intensities on the image sensor 180, detecting the full calibration line with all the pixels present in the line can be a challenging task. Therefore, a larger block, such as the 4×4 (four pixels by four pixels) calibration block in FIG. 6, with higher light throughput is used to assist the primary block in defining the position of the frames. However, it should be noted that a single calibration line with all the pixels present in the line is sufficient for the purpose of image calibration and subsequent image reconstruction. FIG. 7 shows an example compressed and encoded image after taking a single image acquisition or scan of a static scene which contains a trace line of a calibration block generated as a result of mirror sweeping. In this example, a single calibration block is provided in the peripheral area of the mask pattern. Here, the canny edge detection algorithm may be used to recognise the boundaries in a selected segment of the scanned data and detect the vertical movements for each frame with respect to the first (reference) frame on the image sensor. The extracted motion profile is noted as the matrix C in the forward model of the video reconstruction algorithm, which will be described below.

At step 530, a plurality of individually encoded, temporally separated, and spatially partially overlapped 2D image frames that are evenly distributed across the full width of the sensing area of the image sensor 180 may be captured during a single image acquisition (or a single exposure). Any two adjacent detected image frames may be spatially shifted by a single pixel width. Note that, temporal scanning of a dynamic scene in a single exposure successfully eliminates the limitation of digitization and readout time of the image sensor suffered by the conventional high-speed imaging systems, e.g., Brandaris 128.

At step 540, the plurality of the compressed and encoded 2D image frames may be subsequently reconstructed to a video comprising a plurality of decoded or original images of the dynamic scene. Reconstructing image frames of the captured scene from the individually encoded and spatially partially overlapped images is an ill-posed problem as there is no unique solution. To tackle this problem, the data acquisition model may be established by considering the properties of the components in the system. The mathematical representation of the forward model may be formulated as:

y=TCAx+n, [3]

where y∈R^{MN+(F-1)M×1} is the package of encoded image frames captured by the image sensor, T∈R^{MN+(F-1)M×MNF} is the linear operator of shifting and overlapping, C∈R^{MNF×MNF} is the mirror motion profile obtained from the calibration step 520 in the form of a diagonal matrix, A∈R^{MNF×MNF} represents the encoded image frames as a diagonal matrix, x∈R^{MNF×1} are the original image frames, and n is the additive zero mean Gaussian noise. As described above, y represents the spatially compressed image data captured on the image sensor SEN that contains the aggregate of individually encoded and temporally separated frames where each frame is positioned with a single pixel shift along the sweeping direction with respect to its adjacent frames. M and N are the number of associated rows and the columns in each frame respectively. The shifting and overlapping operation is handled by a linear operator T and is built upon p identity matrices with dimension of l∈R^{MN×MN}.

Estimating x from y in equation [3] is known as an ill-posed linear inverse problem (LIP), i.e, there is more than one feasible solution to this problem. The formulated sensing matrix referred to as TCA in equation [3] enables an extremely high compression to be achieved on the observed temporally separated and spatially partially overlapped data. However, it should be noted that this type of compression does not satisfy the Restricted Isometry Property (RIP) used in the general compressive sensing framework. Therefore, data reconstruction may suffer inevitable artefacts known as a lossy recovery. Many reconstruction methods such as dictionary learning based, Bayesian, Gaussian mixture models and maximum likelihoods have demonstrated their capabilities in solving such equations. Among these, the Alternating Direction Method of Multipliers (ADMM) method is adopted here. The ADMM method applies variable splitting to the cost function, e.g., equation [1], and solves the shaped Lagrange equations accordingly. This approach transforms equation [3] into a minimization problem and solves the equation by minimizing the energy function via the repetitive calculation of the total variation (TV) in the signal.

One of the advantages of using TV over the other regularizers is the edge preservation property that prevents hard smoothing of the edge features. This key characteristic averts the spatial information from merging with the background features and therefore preventing the loss of the critical information such as the boundaries and intensity amplitudes per pixels that are essential to applications such as high throughput cell screening where the cell counting and the exact shape of the individual cells are the defining factors in the analysis.

Furthermore, even though not all applications of the high-speed imaging require the data to be encrypted, there are some fields such as the medical and military based applications that demand a highly efficient and speedy data encryption methods. The conventional data encoding techniques require all the raw data to be stored in an accessible storage unit prior to going through the encryption stage. This defect in the process leaves the confidential data exposed to the possible threats. The joint operation of encoding and compression functions as adopted in the above embodiments enable the real-time data encryption and eliminates the potential exposure of the data. This key feature facilitates the imaging of the highly sensitive data such as the screening of the medical test samples from the patients or testing of a newly developed component in the military. Consequently, image scans can be securely conducted by any other members of the staff and the obtained compressed and encoded image data will be handed back to the authorised affiliate for further processing such as data reconstruction, data analysis and diagnostics.

Note that, the ADMM-TV based reconstruction algorithm can be further extended to the colour domain where the red, green and blue (RGB) channels of the image sensor are separated and the reconstruction algorithm is applied on each colour channel individually. After data reconstruction, the corresponding images in three colour channels are then merged together to form single images. In this way, coloured reconstruction of the image frames can be achieved. The process of reconstructing the individual channels are decoupled form each other therefore they can be determined in a parallel fashion. Therefore, in some embodiments, at step 540, the coloured reconstruction algorithm may be used to reconstruct the image data obtained after performing step 530 into a plurality of coloured images.

Note that, the above-described operation steps, i.e. 510 to 540 in FIG. 5, are only an example. Other different ways of operating the imaging apparatus are equally applicable so long as they follow the basic operating principle of the image apparatus. One or more steps of the operation of the imaging apparatus may be performed automatically by the control unit. In some embodiments, the control unit may be a computer apparatus such that the operation steps may be embodied in the form of computer readable instructions for running on suitable computer apparatus, or in the form of a computer system comprising at least a storage means for storing instructions embodying the operation concepts described herein and a processing unit for performing the instructions. For example, the aforementioned video reconstruction algorithm may be embodied as a computer program stored in a computer storage means, which may be a computer memory, and/or disk drive, optical drive or similar. Upon receiving a command to carry out the video reconstruction, the processing unit may follow the corresponding instructions stored in the computer memory and perform the instructed tasks in an automatic manner. The computer system may also comprise a display unit and one or more input/output devices.

Note that, the above description is for illustration only and other embodiments and variations may be envisaged without departing from the scope of the invention.

1. An imaging apparatus comprising:
an optical encoder configured to provide an encoded image by encoding an image of an object with at least one mask pattern;
a rotating mirror configured to rotate and to receive and subsequently project said encoded image; and
an image sensor configured to receive said encoded image projected by said rotating mirror;
wherein, said rotating mirror is operable to single-directionally rotate a rotation angle such that a plurality of said encoded images, which are individually projected by said rotating mirror at any rotation moment and are spatially shifted as a result of rotation of said rotating mirror, are swept across said image sensor for a single image acquisition.

2. The imaging apparatus as claimed in claim 1, wherein said plurality of said projected encoded images are detected by said image sensor as a plurality of detected encoded images, and further wherein, said plurality of detected encoded images are spatially shifted by a single pixel size of said image sensor.

3. The imaging apparatus as claimed in claim 2, wherein said plurality of said projected encoded images cover an entire sensing area of said image sensor.

4. The imaging apparatus as claimed in claim 1, wherein each of said plurality of said projected encoded images comprises a pixel size substantially that of said image sensor.

5. The imaging apparatus as claimed in claim 1, wherein said optical encoder comprises a physical mask with at least one fixed mask pattern.

6. The imaging apparatus as claimed in claim 1, wherein said optical encoder comprises a transmissive spatial light modulator (SLM) or a reflective SLM.

7. The imaging apparatus as claimed in claim 6, wherein said optical encoder comprises at least one variable mask pattern, and further wherein, said at least one variable mask pattern is arranged to be adjustable during operation of said imaging apparatus.

8. The imaging apparatus as claimed in claim 1, wherein said at least one mask pattern comprises one or more binary patterns.

9. The imaging apparatus as claimed in claim 1, further comprising a first optical element 160 configured to convey said encoded image onto said rotating mirror.

10. The imaging apparatus as claimed in claim 9, wherein said first optical element is configured to focus said encoded image onto said rotating mirror and preferably comprises an optical lens or a curved mirror.

11. The imaging apparatus as claimed in claim 1, further comprising a second optical element 140 configured to form said image of said object on said optical encoder.

12. The imaging apparatus as claimed in claim 11, wherein the second optical element comprises any selected from the range: an optical lens, a curved mirror, an optical assembly.

13. The imaging apparatus as claimed in claim 1, wherein the image of the object is formed with natural light.

14. The imaging apparatus as claimed in claim 1, wherein said image of said object is formed after illumination of said object with an external light source.

15. The imaging apparatus as claimed in claim 14, wherein said image of said object is formed with fluorescence emitted from said object excited by said external light source.

16. The imaging apparatus as claimed in claim 1, the imaging apparatus further comprising a control unit operable to perform one or more operation tasks.

17. The imaging apparatus as claimed in claim 16, wherein said control unit is operable to apply at least one mask pattern to said optical encoder.

18. The imaging apparatus as claimed in claim 16, wherein said control unit is operable to calibrate said imaging apparatus with said at least one mask pattern.

19. The imaging apparatus as claimed in claim 16, wherein said control unit is operable to perform one or more image acquisitions so as to capture said plurality of said detected encoded images.

20. The imaging apparatus as claimed in claim 19, wherein said control unit is operable to command said rotating mirror to single-directionally rotate said rotation angle.

21. The imaging apparatus as claimed in claim 16, wherein said control unit is operable to perform data reconstruction in order to reconstruct said plurality of detected encoded images into original images of said object.

22. The imaging apparatus as claimed in claim 21, wherein said control unit is operable to run a data reconstruction algorithm which is based on alternating direction method of multipliers with total-variation regularizer (ADMM-TV) method.

23. A method of high speed imaging, comprising:
generating an encoded image by encoding an image of an object with at least one mask pattern;
receiving and subsequently projecting said encoded image by a rotating mirror configured to rotate; and
receiving said encoded image projected from said rotating mirror by an image sensor;
wherein, by single-directionally rotating said rotating mirror a rotation angle, a plurality of said encoded images, which are individually projected by said rotating mirror at any rotation moment and are spatially shifted as a result of rotation of said rotating mirror, are swept across said image sensor for a single image acquisition.

24. The method of high speed imaging as claimed in claim 23, further comprising: obtaining a plurality of detected encoded images by detecting said plurality of said projected encoded images, wherein, said plurality of detected encoded images are spatially shifted by a single pixel size of said image sensor.

25. The method of high speed imaging as claimed in claim 23, further comprising:
generating one or more calibration trace lines by using one or more calibration blocks;
correcting position errors of said encoded images on said image sensor by using said one or more calibration trace lines.

26. The method of high speed imaging as claimed in claim 24, further comprising:
reconstructing said plurality of detected encoded images obtained with said single image acquisition into original images of said object.

27. The method of high speed imaging claimed in claim 26, wherein said reconstructing of said plurality of said encoded images is conducted by a data reconstruction algorithm which is based on alternating direction method of multipliers with total-variation regularizer (ADMM-TV) method.

28. The method of high speed imaging claimed in claim 27, further comprising:
separating said plurality of detected encoded images into three sets of single-coloured image data corresponding respectively to red, green and blue channels of said image sensor,
reconstructing each of said three sets of single-coloured image data into a set of single-coloured original images by using said data reconstruction algorithm such that three sets of single-coloured original images are obtained; and
generating a set of coloured original images by merging corresponding images of said three sets of single-coloured original images.
